(19) United States
(12) Patent Application Publication
(10) Pub. No.: US 2025/0036716 A1
(43) Pub. Date: Jan. 30, 2025

(54) PARALLEL COMPUTATION METHODS AND SYSTEMS FOR MULTIPLYING SYMMETRIC MATRICES WITH VECTORS

(71) Applicant: ZHEJIANG LINGDI DIGITAL TECHNOLOGY CO., LTD., Hangzhou (CN)

(72) Inventors: Chen LIU, Hangzhou (CN); Huamin WANG, Hangzhou (CN)

(73) Assignee: ZHEJIANG LINGDI DIGITAL TECHNOLOGY CO., LTD., Hangzhou (CN)

(21) Appl. No.: 18/890,717

(22) Filed: Sep. 19, 2024

Related U.S. Application Data
(63) Continuation-in-part of application No. PCT/CN2022/089298, filed on Apr. 26, 2022.

(51) Int. Cl. G06F 17/16

(52) U.S. Cl. CPC G06F 17/16

(57) ABSTRACT

Parallel computation methods and systems for multiplying symmetric matrices with vectors are provided. The method may include acquiring a symmetric matrix and a vector; determining a count of a plurality of threads; dividing the symmetric matrix into a symmetric axis region, an upper triangular region, and a lower triangular region; obtaining symmetric axis data by determining a product of the symmetric axis region and the vector; dividing the upper triangular region or the lower triangular region into one or more subregions; for each of the one or more subregions, determining one or more candidate axes parallel to the symmetric axis, and for each of the one or more candidate axes, obtaining two sets of data or four sets of data by performing two multiplication operations on the candidate axis; and obtaining a result of multiplying the symmetric matrix with the vector.

### CROSS-REFERENCE TO RELATED APPLICATIONS

This application is a continuation-in-part of International Application No. PCT/CN2022/089298, filed on Apr. 26, 2022, the entire contents of which are incorporated herein by reference.

### TECHNICAL FIELD

The present disclosure relates to the field of matrix data processing, and in particular, to parallel computation methods and systems for multiplying symmetric matrices with vectors.

### BACKGROUND

A real matrix, denoted as A, is a data block composed of M×N real numbers. A vector, denoted as x, may be considered as a matrix composed of N×1 real numbers. A multiplication result, denoted as y, of the matrix A and the vector×is a vector of M×1. The multiplication of the matrix A with the vector×is defined as follows:

$$Ax = [ \begin{matrix}{a}_{0 , 0} & ⋯ & {a}_{0 , N - 1} \\ ⋮ & ⋱ & ⋮ \\ {a}_{M - 1 , 0} & ⋯ & {a}_{M - 1 , N - 1}\end{matrix} ] [ \begin{matrix}{x}_{0} \\ ⋮ \\ {x}_{N - 1}\end{matrix} ] = [ \begin{matrix}{a}_{0 , 0} {x}_{0} & + & ⋯ & + & {a}_{0 , N - 1} {x}_{N - 1} \\ & & & ⋮ & \\ {a}_{M - 1 , 0} {x}_{0} & + & ⋯ & + & {a}_{M - 1 , N - 1} {x}_{N - 1}\end{matrix} ] = [ \begin{matrix}{y}_{0} \\ ⋮ \\ {y}_{N - 1}\end{matrix} ] = y$$

By performing the multiplication of the matrix A with the vector×in parallel through a processor can effectively reduce data processing time. When a parallel algorithm is developed, an important issue is how to avoid a write conflict. For instance, the write conflict refers to that when a plurality of concurrently running threads need to write into a same memory address simultaneously, a result written earlier can be overwritten by a result written later without any operations, leading to an incorrect result. For example, if two threads simultaneously add 1 into a same memory address, and an original value is 0, a correct result should be 2. However, if the two threads execute in the following operations in order, the result in the memory is 1 due to the write conflict.

Thread A: Read the memory, and obtain the original value of 0,
Thread B: Read the memory, and obtain the original value of 0,
Thread A: Perform an addition 0+1=1, and obtain a result of 1,
Thread B: Perform an addition 0+1=1, and obtain a result of 1,
Thread A: Write the result of 1 back to the memory,
Thread B: Write the result of 1 back to the memory.

When a symmetric matrix is computed using existing techniques, a_{i,j}=a_{j,i} is not considered, or an upper triangular region of the symmetric matrix is simply ignored. Without considering a_{i,j}=a_{j,i}, same data is read twice, resulting in the redundancy in the algorithm. Since cost for reading and writing is often much greater than cost for performing multiplication computation during the computation, it is desired that the same data is read once. Simply ignoring the upper triangular region of the symmetric matrix increases a computation workload and a computation time, which results in low computation efficiency.

A potential write-back conflict is an important factor reducing the accuracy and efficiency of the computation of the symmetric matrix. In addition, during the parallel computation, the thread workload is extremely unbalanced, which wastes thread resources of the processor. Some threads become idle after processing data, while some other threads need to process a large amount of data.

### SUMMARY

In an aspect of the present disclosure, a parallel computation method for multiplying a symmetric matrix with a vector is provided. The method may be implemented on a computing device having at least one processor and at least one storage device. The at least one processor may include a plurality of threads capable of parallel computation, and the at least one storage device may include a first storage device, a second storage device, and a third storage device. The method may include acquiring a symmetric matrix and a vector to be computed; determining a count of the plurality of threads; dividing, based on a symmetric axis of the symmetric matrix, the symmetric matrix into a symmetric axis region, an upper triangular region, and a lower triangular region; obtaining symmetric axis data by determining a product of the symmetric axis region and the vector, and writing the symmetric axis data into one of the first storage device, the second storage device, and the third storage device; dividing, based on the count of the plurality of threads, the upper triangular region or the lower triangular region into one or more subregions in rows; for each of the one or more subregions, determining one or more candidate axes parallel to the symmetric axis; for each of the one or more candidate axes, obtaining two sets of data or four sets of data by performing two multiplication operations on the candidate axis through at least a portion of the plurality of threads, and writing the two sets of data respectively into the first storage device or the second storage device, or writing the four sets of data respectively into the first storage device, the second storage device, or the third storage device; and obtaining a result of multiplying the symmetric matrix with the vector by constructing a target matrix based on accumulated data in the first storage device, the second storage device, and the third storage device after computing the symmetric axis region and the one or more subregions.

In some embodiments, the first storage device and the third storage device may be registers, and the second storage device may be a memory.

In some embodiments, a first distance between the at least one processor and each of the first storage device and the third storage device may be less than a second distance between the at least one processor and the second storage device.

In some embodiments, a first storage capacity of the first storage device or the third storage device may be smaller than a second storage capacity of the second storage device.

In some embodiments, the dividing, based on the count of the plurality of threads, the upper triangular region or the lower triangular region into one or more subregions in rows may include dividing the upper triangular region or the lower triangular region into at least one of a first subregion and a second subregion. A count of rows in the first subregion may be equal to the count of the plurality of threads, and a count of rows in the second subregion may be less than the count of the plurality of threads.

In some embodiments, for each of the one or more subregions, the determining one or more candidate axes parallel to the symmetric axis may includes in each first subregion, determining the one or more candidate axes including at least one first axis and at least one second axis, wherein a count of elements in the first axis is equal to the count of the plurality of threads, and a count of elements in the second axis is less than the count of the plurality of threads; and in each second subregion, determining the one or more candidate axes including at least one second axis.

In some embodiments, for each first axis, two sets of data may be obtained by performing two first multiplication operations on the first axis through the plurality of threads, one of the two sets of data may be written into one of the first storage device and the second storage device, and the other one of the two sets of data may be written into the other one of the first storage device and the second storage device.

In some embodiments, the first storage device may include a first storage matrix, the second storage device may include a second storage matrix, and the two first multiplication operations may include: performing a multiplication operation between an element a_{i,j} in the first axis and an element xⱼ in the vector to obtain a product a_{i,j}xⱼ, and performing a multiplication operation between the element a_{i,j} and an element xᵢ in the vector to obtain a product a_{i,j}xᵢ; accumulating the product a_{i,j}xⱼ into an i-th row rᵢ of the first storage matrix in the first storage device; and accumulating the product a_{i,j}xᵢ into a j-th row yⱼ of the second storage matrix in the second storage device.

In some embodiments, for each second axis, the parallel computation method may further comprise determining whether a complementary second axis of the second axis exists, the complementary second axis being a second axis located in the same subregion as the second axis, and a sum of counts of elements in the complementary second axis and the second axis being equal to the count of the plurality of threads, wherein: when a complementary second axis does not exist, two sets of data are obtained by performing the two second multiplication operations on the second axis through a portion of the plurality of threads, one of the two sets of data is written into one of the first storage device and the second storage device, and the other one of the two sets of data is written into the other one of the first storage device and the second storage device; or when a complementary second axis exists, four sets of data are by obtained by performing the two second multiplication operations on the second axis and the complementary second axis, respectively, and the four sets of data are written into the first storage device, the second storage device, and the third storage device, respectively.

In some embodiments, the first storage device may include a first storage matrix, the second storage device may include a second storage matrix, the third storage device may include a third storage matrix, when a complementary second axis does not exist, the performing the two second multiplication operations on the second axis may include: performing a multiplication operation between an element a_{i,j} in the second axis and an element xⱼ in the vector to obtain a product a_{i,j}xⱼ, and performing a multiplication operation between the element a_{i,j} and an element xᵢ in the vector to obtain a product a_{i,j}xᵢ; accumulating the product a_{i,j}xⱼ into an i-th row rᵢ of the first storage matrix in the first storage device; and accumulating the product a_{i,j}xᵢ into a j-th row yⱼ of the second storage matrix in the second storage device; or when a complementary second axis exists, the performing the two second multiplication operations on the second axis and the complementary second axis, respectively, may comprise performing a multiplication operation between the element a_{i,j} on the second axis and the element xⱼ in the vector to obtain a product a_{i,j}xⱼ, performing a multiplication operation between the element a_{i,j} and the element xᵢ in the vector to obtain a product a_{i,j}xᵢ, performing a multiplication operation between an element a_{m,n} in the complementary second axis and an element xₙ in the vector to obtain a product a_{m,n}xₙ, performing a multiplication operation between the element a_{m,n} and an element xₘ in the vector to obtain a product a_{m,n}xₘ; accumulating the product a_{i,j}xⱼ into an i-th row rᵢ of the first storage matrix in the first storage device; accumulating the product a_{i,j}xᵢ into a j-th row yⱼ of the second storage matrix in the second storage device; accumulating the product a_{m,n}xₙ into an m-th row yₘ of the second storage matrix in the second storage device; and accumulating the product a_{m,n}xₘ into an n-th row sₙ of the third storage matrix in the third storage device.

In some embodiments, the counts of elements in the second axis and the complementary second axis may be different, the four sets of data may include two first sets of data and two second sets of data, the two first sets of data may be obtained by performing the two multiplication operations on one of the second axis and the complementary second axis with a greater count of elements, one of the two first sets of data may be written into one of the first storage device and the second storage device, the other one of the two first sets of data may be written into the other one of the first storage device and the second storage device; and the two second sets of data may be obtained by performing the two multiplication operations on the other one of the second axis and the complementary second axis with a smaller count of elements, one of the two second sets of data may be written into the third storage device, the other one of the two second sets of data may be written into the first storage device or the second storage device.

In some embodiments, an order of the symmetric matrix may be denoted as M, and the count of the plurality of threads may be denoted as L, wherein when M=2nL+1, the upper triangular region or the lower triangular region is divided into 2n first subregions in rows based on the count of the plurality of threads, wherein M, L, and n are positive integers.

In another aspect of the present disclosure, a parallel computation system for multiplying a symmetric matrix with a vector is provided. The parallel computation system may include at least one storage device and at least one processor. The at least one storage device may include a set of instructions, the at least one storage device including a first storage device, a second storage device, and a third storage device. The at least one processor may be configured to communicate with the at least one storage device, the at least one processor including a plurality of threads capable of parallel computation. When executing the set of instructions, the at least one processor may be configured to direct the system to perform at least one operation including: acquiring a symmetric matrix and a vector to be computed; determining a count of the plurality of threads; dividing, based on a symmetric axis of the symmetric matrix, the symmetric matrix into a symmetric axis region, an upper triangular region, and a lower triangular region; obtaining symmetric axis data by determining a product of the symmetric axis region and the vector, and writing the symmetric axis data into one of the first storage device, the second storage device, and the third storage device; dividing, based on the count of the plurality of threads, the upper triangular region or the lower triangular region into one or more subregions in rows; for each of the one or more subregions, determining one or more candidate axes parallel to the symmetric axis; for each of the one or more candidate axes, obtaining two sets of data or four sets of data by performing two multiplication operations on the candidate axis through at least a portion of the plurality of threads, and writing the two sets of data respectively into the first storage device or the second storage device, or writing the four sets of data respectively into the first storage device, the second storage device, or the third storage device; and obtaining a result of multiplying the symmetric matrix with the vector by constructing a target matrix based on accumulated data in the first storage device, the second storage device, and the third storage device after computing the symmetric axis region and the one or more subregions.

In another aspect of the present disclosure, a non-transitory computer readable medium is provided. The non-transitory computer readable medium may include at least one set of instructions. When executed by a computing device having at least one processor and at least one storage device, the at least one processor including a plurality of threads capable of parallel computation, and the at least one storage device including a first storage device, a second storage device, and a third storage device, the at least one set of instruction may direct the computing device to perform a method including: acquiring a symmetric matrix and a vector to be computed; determining a count of the plurality of threads; dividing, based on a symmetric axis of the symmetric matrix, the symmetric matrix into a symmetric axis region, an upper triangular region, and a lower triangular region; obtaining symmetric axis data by determining a product of the symmetric axis region and the vector, and writing the symmetric axis data into one of the first storage device, the second storage device, and the third storage device; dividing, based on the count of the plurality of threads, the upper triangular region or the lower triangular region into one or more subregions in rows; for each of the one or more subregions, determining one or more candidate axes parallel to the symmetric axis; for each of the one or more candidate axes, obtaining two sets of data or four sets of data by performing two multiplication operations on the candidate axis through at least a portion of the plurality of threads, and writing the two sets of data respectively into the first storage device or the second storage device, or writing the four sets of data respectively into the first storage device, the second storage device, or the third storage device; and obtaining a result of multiplying the symmetric matrix with the vector by constructing a target matrix based on accumulated data in the first storage device, the second storage device, and the third storage device after computing the symmetric axis region and the one or more subregions.

According to some embodiments of the present disclosure, the parallel computation method and system for multiplying the symmetric matrix with the vector are provided, which can improve the accuracy and efficiency of multiplication computation between the symmetric matrix and the vector. By reasonably planning a sequence for processing the elements in the matrix, thread resources can be reasonably allocated, which can avoid write conflicts effectively and cause the plurality of threads to compute in parallel, thereby improving the efficiency of the computation, balancing thread loads, and reasonably distributing the thread resources.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary parallel computation system according to some embodiments of the present disclosure;

FIG. 2 is a flowchart illustrating an exemplary parallel computation process for multiplying a symmetric matrix with a vector according to some embodiments of the present disclosure;

FIG. 3 is a schematic diagram illustrating an exemplary symmetric matrix divided into a symmetric axis region, an upper triangular region, and a lower triangular region based on a symmetric axis of the symmetric matrix according to some embodiments of the present disclosure; and

FIG. 4 is a schematic diagram illustrating an exemplary structure of a parallel computation system for multiplying a symmetric matrix with a vector according to some embodiments of the present disclosure.

In the drawings, 100 represents a parallel computation system, 110 represents at least one processor, 112 represents a thread, 114 represents a thread, 116 represents a thread, 118 represents a thread, 120 represents at least one storage device, 122 represents a first register, 124 represents a second register, 126 represents a third register, 132 represents a first memory, 134 represents a second memory, 300 represents a parallel computation system, 301 represents an input unit, 302 represents a region division unit, 303 represents a symmetric axis computation unit, 304 represents a first computation unit, 305 represents a second computation unit, and 306 represents a result computation unit.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “may include,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, the operations may be executed in reverse order or simultaneously. Additionally, one or more other operations may be added to these processes, or one or more operations may be removed from these processes.

It should be noted that a multiplication operation of a symmetric matrix with a vector in the present disclosure strictly comply with rules of matrix multiplication. The symmetric matrix is represented as M×N, the vector is represented as N×1, M is equal to N, and a_{i,j} is equal to a_{j,i}. i may be an i-th row of the symmetric matrix, and j may be a j-th column of the symmetric matrix. M, N, i, and j are positive integers. An order of the symmetric matrix may be required to be greater than or equal to 3. In some embodiments, a second-order symmetric matrix may also be processed using the method of the present disclosure. The order may include an odd number or an even number.

It should be noted that a count (or number) of threads represents a maximum count of threads that can run in parallel. Different processors may have different counts of threads. Using all threads may represent running in parallel with the count of threads, and using a portion of threads may represent performing parallel calculations with threads less than the count of threads. The count of threads may be an odd number or an even number greater than 1. Generally speaking, in order to avoid wasting thread resources, the count of threads should be less than or equal to the order. The higher the count of threads, the higher the order of the symmetric matrix that can be processed in parallel.

It should be noted that a symmetric axis of the symmetric matrix is a main diagonal, a symmetric axis region of the symmetric matrix is a region where the symmetric axis is located, an upper triangular region of the symmetric matrix is a triangular region above the symmetric axis in the symmetric matrix, and a lower triangular region of the symmetric matrix is a triangular region below the symmetric axis in the symmetric matrix. In the present disclosure, the upper triangular region and the lower triangular region do not include the symmetric axis.

It should be noted that computation of a region with a vector in the present disclosure refers to computation of elements in the region with elements in the vector. For example, parallel computation of the symmetric axis region with the vector refers to that each element in the symmetric axis region is multiplied with an element at a corresponding location in the vector.

It should be noted that, in the present disclosure, terms “first axis” and “second axis” refer to lines parallel to the symmetric axis, which are used to describe positions of elements in the matrix for the purposes of illustration. Computations of the first axis and the second axis refer to computation of elements in the first axis and second axis, respectively. The second axis may include one or more elements.

The terms used in various embodiments of the present disclosure are merely provided for purposes of describing specific embodiments, and are not intended to limit the scope of embodiments of the present disclosure. As used in the present disclosure and the claims, the singular form may also include the plural form unless the context clearly indicates otherwise. Unless otherwise specified, all terms used herein (including technical and scientific terms) have the same meanings as understood by those skilled in the art or in the relevant field. The terms, as defined in commonly used dictionaries, are interpreted to have the same meanings as they would in the context of the relevant technical field, and are not interpreted with an idealized or overly formal meaning unless clearly specified in the embodiments of the present disclosure.

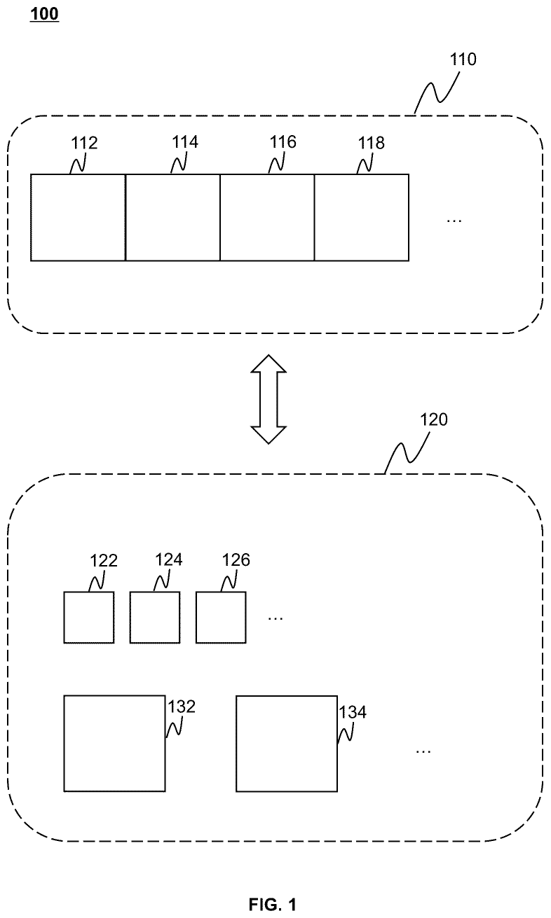

FIG. 1 is a schematic diagram illustrating an exemplary parallel computation system 100 according to some embodiments of the present disclosure. As shown in FIG. 1, the parallel computation system 100 may include at least one processor 110 and at least one storage device 120. In some embodiments, the at least one processor 110 and the at least one storage device 120 may be connected to and/or communicate with each other via a wireless connection, a wired connection, or a combination thereof. The connection between the components in the parallel computation system 100 may be variable. Merely by way of example, the at least one processor 110 may be connected to the at least one storage device 120 directly, as illustrated in FIG. 1. As another example, the at least one processor 110 may be connected to the at least one storage device 120 through a network.

The at least one processor 110 may process data and/or information obtained from one or more components (e.g., the at least one storage device 120) of the parallel computation system 100. For example, the at least one processor 110 may perform a parallel computation process for multiplying a symmetric matrix with a vector. In some embodiments, the at least one processor 110 may be a single server or a server group. The server group may be centralized or distributed. In some embodiments, the at least one processor 110 may be local or remote. In some embodiments, the at least one processor 110 may be implemented on a cloud platform. In some embodiments, the at least one processor 110 may include a CPU and/or a GPU.

In some embodiments, the at least one processor 110 may be implemented by a computing device. For example, the computing device may include a processing device, a storage, an input/output (I/O), and a communication port. The processing device may execute computer instructions (e.g., program codes) and perform functions of the at least one processor 110 in accordance with the techniques described herein. The computer instructions may include, for example, routines, programs, objects, components, data structures, procedures, modules, and functions, which perform particular functions described herein.

In some embodiments, as shown in FIG. 1, the at least one processor 110 may include multiple threads, such as, a thread 112, a thread 114, a thread 116, a thread 118, etc. A thread refers to the smallest sequence of programmed instructions that can be managed independently by a scheduler. In some embodiments, at least a portion of the multiple threads may run in parallel. For example, the thread 112, the thread 114, and the thread 116 may be used to perform the parallel computation process.

The at least one storage device 120 may store data/information obtained from the at least one processor 110 and/or any other component of the parallel computation system 100. In some embodiments, the at least one storage device 120 may include a mass storage, a removable storage, a volatile read-and-write memory, a read-only memory (ROM), or the like, or any combination thereof. For example, the at least one storage device 120 may include one or more registers (e.g., a first register 122, a second register 124, a third register 126, etc.) and/or one or more memories (e.g., a first memory 132, a second memory 134, etc.). Exemplary registers may include an instruction register (IR), a program counter (PC), a control register, or the like, or any combination thereof. In some embodiments, features (e.g., the position, the storage capacity, the reading speed, etc.) of a register may be different from those of a memory. For example, a first distance between the at least one processor 110 and each of the one or more registers (e.g., the first register 122, the second register 124, the third register 126, etc.) may be less than a second distance between the at least one processor 110 and each of the one or more memories (e.g., the first memory 132, the second memory 134, etc.). In other words, the register(s) are closer to the at least one processor. In some embodiments, since the register(s) are closer to the at least one processor, the register(s) have a quicker reading speed than the one or more memories. As another example, a first storage capacity of each of the one or more registers may be smaller than a second storage capacity of each of the one or more memories. In some embodiments, the at least one storage device 120 may store one or more programs and/or instructions to perform exemplary methods described in the present disclosure.

In some embodiments, the parallel computation system 100 may include one or more additional components and/or one or more components of the parallel computation system 100 described above may be omitted. Additionally or alternatively, two or more components of the parallel computation system 100 may be integrated into a single component. A component of the parallel computation system 100 may be implemented on two or more sub-components.

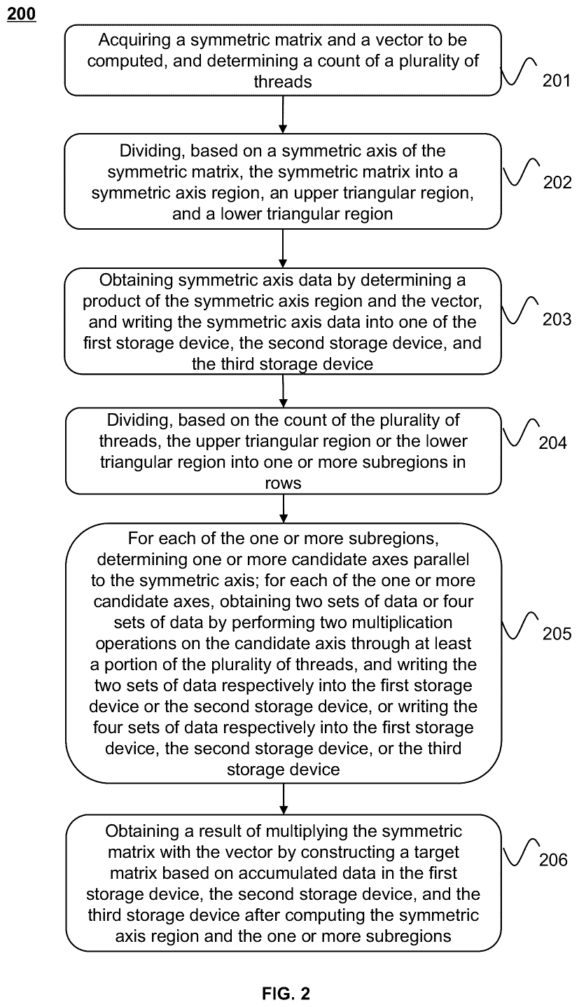

FIG. 2 is a flowchart illustrating an exemplary parallel computation process 100 for multiplying a symmetric matrix with a vector according to some embodiments of the present disclosure.

In some embodiments, the process 200 may be implemented on a computing device having at least one processor (e.g., the at least one processor 110) and at least one storage device (e.g., the at least one storage device 120). The at least one processor may include a plurality of threads (e.g., the thread 112, the thread 114, and the thread 116) capable of parallel computation, and the at least one storage device may include a first storage device (e.g., the first register 122), a second storage device (e.g., the first memory 132), and a third storage device (e.g., the second register 124). The process 200 may include following operations.

In 201, a symmetric matrix and a vector to be computed may be acquired, and a count of the plurality of threads may be determined.

A matrix may be a data block composed of M×N numbers or elements. In the symmetric matrix, M may be equal to N, and a_{i,j} may be equal to a_{j,i}. i may correspond to an i-th row of the symmetric matrix, and j may correspond to a j-th column of the symmetric matrix. M, N, i, and j are positive integers. An order of the symmetric matrix may be greater than or equal to 2. The order may include an odd number or an even number.

A vector, denoted as x, may be a matrix composed of N×1 numbers or elements.

In some embodiments, the count of the plurality of threads may represent a maximum count of threads that can run in parallel. For example, referring to FIG. 1, if the at least one processor 110 includes the thread 112, the thread 114, the thread 116, the thread 118, etc., and the thread 112, the thread 114, and the thread 116 can run in parallel, the count of the plurality of threads may be 3.

In 202, the symmetric matrix may be divided into a symmetric axis region, an upper triangular region, and a lower triangular region based on a symmetric axis of the symmetric matrix.

The symmetric axis refers to a main diagonal of the symmetric matrix, the symmetric axis region refers to a region where the symmetric axis is located, the upper triangular region refers to a triangular region above the symmetric axis in the symmetric matrix, and the lower triangular region refers to a triangular region below the symmetric axis in the symmetric matrix. In the present disclosure, the upper triangular region and the lower triangular region do not include the symmetric axis.

In 203, symmetric axis data may be obtained by determining a product of the symmetric axis region and the vector, and the symmetric axis data may be written into the at least one storage device. For example, the symmetric axis data may be written into one of the first storage device, the second storage device, and the third storage device.

In 204, the upper triangular region or the lower triangular region may be divided into one or more subregions in rows based on the count of the plurality of threads.

In some embodiments, the order of the symmetric matrix may be greater than or equal to 3, and the count of the plurality of threads may be greater than or equal to 2.

Correspondingly, the upper triangular region or the lower triangular region may be divided into at least one of a first subregion or a second subregion. A count of rows in the first subregion may be equal to the count of the plurality of threads, and a count of rows in the second subregion may be less than the count of the plurality of threads.

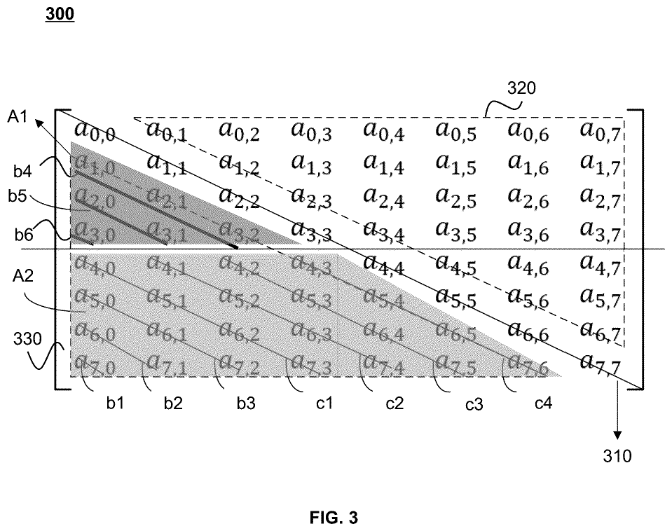

In some embodiments, parity of the order of the symmetric matrix and parity of the count of the plurality of threads may relate to division of the one or more subregions. Referring to FIG. 3, FIG. 3 is a schematic diagram illustrating an exemplary symmetric matrix 300 divided into a symmetric axis region 310, an upper triangular region 320, and a lower triangular region 330 based on a symmetric axis of the symmetric matrix according to some embodiments of the present disclosure. As illustrated in FIG. 3, an 8×8 matrix 300 is divided into the symmetric axis region 310, the upper triangular region 320, and the lower triangular region 330 based on a symmetric axis of the symmetric matrix 300. If a count of a plurality of threads is 4, a first subregion A1 indicated by the grey trapezoid and a second subregion A2 indicated by the grey triangle may be determined.

After the symmetric axis region is removed from the symmetric matrix, a count of rows in the upper triangular region may be the same as a count of rows in the lower triangular region, and elements in the upper triangular region and the lower triangular region may be symmetric about the symmetric axis. Therefore, after processing one of the upper triangular region or the lower triangular region, the processing result of the other one of the upper triangular region or the lower triangular region may be determined. For example, when the count of the plurality of threads is 4 and the order of the matrix is 8, after removing the symmetric axis region, each of the upper triangular region and the lower triangular region may include 7 rows. Each of the upper triangular region and the lower triangular region may be divided into one first subregion and one second subregion. The second subregion may be located at a position with less data within the upper triangular region or the lower triangular region. It should be noted that the position with the less data refers to a region with a smaller count of elements in consecutive rows. For example, as shown in FIG. 3, when the count of the plurality of threads is 4, the first subregion A1 including 4 rows and the second subregion A2 including 3 rows may be determined in the lower triangular region of 7 rows. The second subregion A2 includes three rows with less data, and the first subregion A1 includes four rows with more data.

In 205, for each of the one or more subregions, one or more candidate axes parallel to the symmetric axis may be determined, and for each of the one or more candidate axes, two sets of data or four sets of data may be obtained by performing two multiplication operations on the candidate axis through at least a portion of the plurality of threads, and the two sets of data may be written respectively into the first storage device or the second storage device, or the four sets of data may be written respectively into the first storage device, the second storage device, or the third storage device.

Exemplary candidate axes may include a first axis, a second axis, or a combination thereof. A count of elements in the first axis may be equal to the count of the plurality of threads, and a count of elements in the second axis may be less than the count of the plurality of threads. For example, in each first subregion, the one or more candidate axes including at least one first axis and at least one second axis may be determined. In each second subregion, the one or more candidate axes including at least one second axis may be determined.

In some embodiments, the one or more candidate axes may be formed by lines connecting elements within the matrix. For a single element located in a bottom-left or top-right corner of the symmetric matrix, the element may also be designated as one second axis.

Merely by way of example, for the first subregion A1, among candidate axes c1, c2, c3, c4, b1, b2, and b3 shown in FIG. 3, a count of elements in each of the candidate axes c1, c2, c3, c4 is 4, which is equal to the count of the plurality of threads. Therefore, the candidate axes c1, c2, c3, c4 may be determined as first axes. A count of elements in each of the candidate axes b1, b2, b3 is less than 4, which is less than the count of the plurality of threads. Therefore, the candidate axes b1, b2, b3 may be determined as second axes.

In some embodiments, for each first axis, the two sets of data may be obtained by performing two first multiplication operations on the first axis through the plurality of threads. One of the two sets of data may be written into one of the first storage device and the second storage device, and the other one of the two sets of data may be written into the other one of the first storage device and the second storage device. The first storage device may be a register (e.g., the first register 122) and the second storage device may be a memory (e.g., the first memory 132).

In some embodiments, the first storage device may include a first storage matrix, and the second storage device may include a second storage matrix. The two first multiplication operations may include performing a multiplication operation between an element a_{i,j} in the first axis and an element xⱼ in the vector to obtain a product a_{i,j}xⱼ, and performing a multiplication operation between the element a_{i,j} and an element xᵢ in the vector to obtain a product a_{i,j}xᵢ; accumulating the product a_{i,j}xⱼ into an i-th row rᵢ of the first storage matrix in the first storage device; and accumulating the product a_{i,j}xᵢ into a j-th row yⱼ of the second storage matrix in the second storage device.

In each first axis, since the count of elements is equal to the count of the plurality of threads, the at least one processor can run at a maximum thread capacity when processing the first axis. When each of the plurality of threads processes a non-diagonal element (i.e., an element not in the symmetric axis) a_{i,j}, two products a_{i,j}xᵢ and a_{i,j}xⱼ may be computed. Since the product a_{i,j}xⱼ corresponds to yᵢ, the product a_{i,j}xⱼ may be accumulated into a rⱼ in the at least one storage device (i.e., the first storage device) or a register corresponding to the thread. As the product a_{i,j}xᵢ corresponds to yⱼ, and the product a_{i,j}xᵢ may be directly accumulated into the memory (i.e., the second storage device) yⱼ. Since storage addresses of processing results of different threads are different, writing data into yⱼ in the second storage device will not lead to a write conflict.

In some embodiments, for each second axis, the two sets of data may be obtained by performing two second multiplication operations on the second axis through a portion of the plurality of threads. One of the two sets of data may be written into one of the first storage device and the second storage device, and the other one of the two sets of data may be written into the other one of the first storage device and the second storage device The two sets of data corresponding to the second axis may be written into the first storage device and the second storage device in a similar manner as how the two sets of data corresponding to the first axis may be written into the first storage device and the second storage device, which is not repeated herein.

In some embodiments, the at least one storage device may further include a third storage device, and the third storage device may include a third storage matrix. For example, the third storage device may be a register (e.g., the second register 124). For each second axis, whether a complementary second axis of the second axis exists may be determined. The complementary second axis may be a second axis located in the same subregion as the second axis, and a sum of counts of elements in the complementary second axis and the second axis may be equal to the count of the plurality of threads. In other words, when a sum of counts of elements in two second axes within a same subregion is equal to the count of the plurality of threads, the two second axes may have a complementary relationship. For example, as shown in FIG. 3, the axes c1, c2, c3, and c4 are first axes, and the axes b1, b2, and b3 are second axes. The count of elements in the axis b1 is 1, and the count of elements in the axis b3 is 3. The sum of the counts of elements in the axes b1 and b3 is 4, which corresponds to the count of the plurality of threads. Therefore, the axes b1 and b3 have the complementary relationship. That is, the complementary second axis b1 of the second axis b3 exists.

When a complementary second axis does not exist, two sets of data may be obtained by performing the two second multiplication operations on the second axis through a portion of the plurality of threads. One of the two sets of data may be written into one of the first storage device and the second storage device, and the other one of the two sets of data may be written into the other one of the first storage device and the second storage device. When a complementary second axis exists, four sets of data may be obtained by performing the two second multiplication operations on the second axis and the complementary second axis, respectively, and the four sets of data may be written into the first storage device, the second storage device, and the third storage device, respectively.

In some embodiments, when a complementary second axis does not exist, a multiplication operation may be performed between an element a_{i,j} in the second axis and an element xⱼ in the vector to obtain a product a_{i,j}xⱼ, and a multiplication operation may be performed between the element a_{i,j} and an element xᵢ in the vector to obtain a product a_{i,j}xᵢ. The product a_{i,j}xⱼ may be accumulated into an i-th row rᵢ of the first storage matrix in the first storage device, and the product a_{i,j}xᵢ may be accumulated into a j-th row yⱼ of the second storage matrix in the second storage device.

In some embodiments, when a complementary second axis does not exist, a sum of the count of elements in the second axis and a count of elements in any other second axis within the same subregion is not be equal to the count of the plurality of threads.

Therefore, the two second multiplication operations may be performed on the second axis through a portion of the plurality of threads. In some embodiments, there is only one or no second axis does not have a complementary axis. In some embodiments, when the count of the plurality of threads and the order of the matrix satisfy a condition, all second axes may have their respective complementary axes.

In some embodiments, when a complementary second axis exists, a multiplication operation may be performed between the element a_{i, j} on the second axis and the element xⱼ in the vector to obtain a product a_{i,j}xⱼ, a multiplication operation may be performed between the element a_{i,j} and the element xᵢ in the vector to obtain a product a_{i,j}xᵢ, a multiplication operation may be performed between an element a_{m,n} in the complementary second axis and an element xₙ in the vector to obtain a product a_{m,n}xₙ, and a multiplication operation may be performed between the element aₘ, and an element xₘ in the vector to obtain a product a_{m,n}xₘ. The product a_{i,j}xⱼ may be accumulated into the i-th row rᵢ of the first storage matrix in the first storage device, a_{i,j}xᵢ may be accumulated into the j-th row yⱼ of the second storage matrix in the second storage device, the product a_{m,n}xₘ may be accumulated into an m-th row yₘ of the second storage matrix in the second storage device, and the product a_{m,n}xₘ may be accumulated into an n-th row sₙ of the third storage matrix in the third storage device.

In some embodiments, the counts of elements in the second axis and the complementary second axis may be different, and the four sets of data may include two first sets of data and two second sets of data. The two first sets of data may be obtained by performing the two multiplication operations on one of the second axis and the complementary second axis with a greater count of elements, one of the two first sets of data may be written into one of the first storage device and the second storage device, the other one of the two first sets of data may be written into the other one of the first storage device and the second storage device. The two second sets of data may be obtained by performing the two multiplication operations on the other one of the second axis and the complementary second axis with a smaller count of elements, one of the two second sets of data may be written into the third storage device, the other one of the two second sets of data may be written into the first storage device or the second storage device.

For the two second axes with the complementary relationship, the at least one processor may simultaneously compute the elements in the two second axes, which ensures that the at least one processor operates at the maximum thread capacity, thereby fully utilizing thread resources and minimizing thread idle time. When the two second axes are processed simultaneously, the storage manner may be modified (e.g., by adding the third storage device) to avoid the write conflict between the threads.

It should be noted that the calculation of the symmetry axis region and the calculation of each subregion may be performed in any sequence. For example, the symmetry axis region may be calculated before each sub-region is calculated. As another example, each sub-region may be calculated before the symmetry axis region is calculated. As still another example, it's also possible to interleave the computation of the symmetric axis region while computing each individual subregion.

In 206, a result of multiplying the symmetric matrix with the vector may be obtained by constructing a target matrix based on accumulated data in the first storage device, the second storage device, and the third storage device after computing the symmetric axis region and the one or more subregions.

For example, accumulated data in the first storage device, the second storage device, and the third storage device may be summed into the second storage device.

In some embodiments, if an order of the symmetric matrix is denoted as M, and the count of the plurality of threads is denoted as L, when M=2nL+1, the upper triangular region or the lower triangular region may be divided into 2n first subregions in rows based on the count of the plurality of threads. M, L, and n are positive integers. In this case, no second subregions may exist. For example, when computing a symmetric matrix of 97×97 using 32 parallel threads (i.e., a warp), the multiplication process may include three operations (i.e., computation of upper 32 rows, computation of middle 32 rows, and computation of lower 32 rows).

Taking a symmetric matrix of 8×8 as an example, a lower triangular region of the symmetric matrix may be divided into upper three rows and lower four rows. For purposes of illustration, computation of the lower four rows is described. Four threads may be used to process the lower four rows, respectively. A processing sequence may start from a first axis (e.g., the first axis c4 in FIG. 3) close to a symmetric axis of the symmetric matrix, proceeding from right to left. Registers (i.e., the first storage device and the third storage device) including storage matrices r_{z} and S_{z}, and a memory (i.e., the second storage device) including a storage matrix y_{z} are used in the computation. At the beginning, the storage matrices r_{z} and S_{z} in the registers and the storage matrix y_{z} in the memory may be set to 0. After computing each set of data, the set of data may be gradually accumulated and stored in corresponding positions of the storage matrices r_{z} and S_{z} in the registers and the storage matrix y_{z} in the memory.

At a first stage, elements in the first axes may be processed. When each thread processes a non-diagonal element (i.e., an element not in the symmetric axis) a_{i,j}, two products a_{i,j}xᵢ and a_{i,j}xⱼ may be computed. Since the product a_{i,j}xⱼ corresponds to yᵢ, the product a_{i,j}xⱼ may be accumulated into a row rᵢ in the at least one storage device (i.e., the first storage device) or a register corresponding to the thread. As the product a_{i,j}xᵢ corresponds to yⱼ, and the product a_{i,j}xᵢ may be directly accumulated into a row yⱼ in the memory (i.e., the second storage device). Since storage addresses corresponding to the plurality of threads are different, the product writing into yⱼ in the second storage device will not lead to a write conflict.

$$[ \begin{matrix}◇ & - & - & - & - & - & - & - \\ ◇ & ◇ & - & - & - & - & - & - \\ ◇ & ◇ & ◇ & - & - & - & - & - \\ ◇ & ◇ & ◇ & ◇ & - & - & - & - \\ {a}_{4 , 0} & {a}_{4 , 1} & {a}_{4 , 2} & ◇ & ◇ & - & - & - \\ {a}_{5 , 0} & {a}_{5 , 1} & {a}_{5 , 2} & {a}_{5 , 3} & ◇ & ◇ & - & - \\ {a}_{6 , 0} & {a}_{6 , 1} & {a}_{6 , 2} & {a}_{6 , 3} & {a}_{6 , 4} & ◇ & ◇ & - \\ {a}_{7 , 0} & {a}_{7 , 1} & {a}_{7 , 2} & {a}_{7 , 3} & {a}_{7 , 4} & {a}_{7 , 5} & ◇ & ◇\end{matrix} ] \text{} [ \begin{matrix}{x}_{0} \\ {x}_{1} \\ {x}_{2} \\ {x}_{3} \\ {x}_{4} \\ {x}_{5} \\ {x}_{6} \\ {x}_{7}\end{matrix} ] = [ \begin{matrix}{r}_{0} \\ {r}_{1} \\ {r}_{2} \\ {r}_{3} \\ {r}_{4} + {a}_{4 , 2} {x}_{2} \\ {r}_{5} + {a}_{5 , 3} {x}_{3} \\ {r}_{6} + {a}_{6 , 4} {x}_{4} \\ {r}_{7} + {a}_{7 , 5} {x}_{5}\end{matrix} ] + [ \begin{matrix}{y}_{0} \\ {y}_{1} \\ {y}_{2} + {a}_{4 , 2} {x}_{4} \\ {y}_{3} + {a}_{5 , 3} {x}_{5} \\ {y}_{4} + {a}_{6 , 4} {x}_{6} \\ {y}_{5} + {a}_{7 , 5} {x}_{7} \\ {y}_{6} \\ {y}_{7}\end{matrix} ]$$

In the above matrix, a symbol “-” represents repeated and omitted data (when the lower triangular region is processed as an example), a symbol “ [symbol] ” represents processed data, and data in bold represents data being processed currently.

At a second stage, a left side of the matrix needs to be processed. That is, the first axes have been processed, and the second axes with the complementary relationship begin to be processed. At this point, the processing of the matrix may be shifted to the bottom-left corner, and the processing sequence may be changed from bottom to top:

$$[ \begin{matrix}◇ & - & - & - & - & - & - & - \\ ◇ & ◇ & - & - & - & - & - & - \\ ◇ & ◇ & ◇ & - & - & - & - & - \\ ◇ & ◇ & ◇ & ◇ & - & - & - & - \\ ◇ & ◇ & ◇ & ◇ & ◇ & - & - & - \\ {a}_{5 , 0} & ◇ & ◇ & ◇ & ◇ & ◇ & - & - \\ {a}_{6 , 0} & {a}_{6 , 1} & ◇ & ◇ & ◇ & ◇ & ◇ & - \\ {a}_{7 , 0} & {a}_{7 , 1} & {a}_{7 , 2} & ◇ & ◇ & ◇ & ◇ & ◇\end{matrix} ] [ \begin{matrix}{x}_{0} \\ {x}_{1} \\ {x}_{2} \\ {x}_{3} \\ {x}_{4} \\ {x}_{5} \\ {x}_{6} \\ {x}_{7}\end{matrix} ] = [ \begin{matrix}{r}_{0} \\ {r}_{1} \\ {r}_{2} \\ {r}_{3} \\ {r}_{4} \\ {r}_{5} + {a}_{5 , 0} {x}_{0} \\ {r}_{6} + {a}_{6 , 1} {x}_{1} \\ {r}_{7} + {a}_{7 , 2} {x}_{2}\end{matrix} ] + [ \begin{matrix}{y}_{0} + {a}_{5 , 0} {x}_{5} \\ {y}_{1} + {a}_{6 , 1} {x}_{6} \\ {y}_{2} + {a}_{7 , 2} {x}_{7} \\ {y}_{3} \\ {y}_{4} \\ {y}_{5} \\ {y}_{6} \\ {y}_{7} + {a}_{7 , 0} {x}_{0}\end{matrix} ] + [ \begin{matrix}{s}_{0} + {a}_{7 , 0} {x}_{7} \\ {s}_{1} \\ {s}_{2} \\ {s}_{3} \\ {s}_{4} \\ {s}_{5} \\ {s}_{6} \\ {s}_{7}\end{matrix} ] .$$

In the above matrix, a top thread that processes elements in a top row of the matrix may begin to process an element a_{7,0}. Simultaneously, write-back manners corresponding to the threads may be modified. That is, the product a_{i,j}xⱼ may be accumulated into the memory yᵢ, and the product a_{i,j}xᵢ may be accumulated into the j-th row of the third storage matrix in the third storage device Sⱼ. Therefore, at this stage, no write conflicts may occur between the threads in writing into the memory yᵢ.

At a third stage, the second axis without the complementary relationship may be processed. At the third stage, only a half of diagonal data remains. The modified threads (i.e., the thread that is changed from processing the elements in the top row to processing the element in the bottom-left corner) may be shut down, and the lower threads that process elements in lower rows of the matrix may continue processing the elements in the second axis without the complementary relationship:

$$[ \begin{matrix}◇ & - & - & - & - & - & - & - \\ ◇ & ◇ & - & - & - & - & - & - \\ ◇ & ◇ & ◇ & - & - & - & - & - \\ ◇ & ◇ & ◇ & ◇ & - & - & - & - \\ ◇ & ◇ & ◇ & ◇ & ◇ & - & - & - \\ ◇ & ◇ & ◇ & ◇ & ◇ & ◇ & - & - \\ {a}_{6 , 0} & ◇ & ◇ & ◇ & ◇ & ◇ & ◇ & - \\ ◇ & {a}_{7 , 1} & ◇ & ◇ & ◇ & ◇ & ◇ & ◇\end{matrix} ] [ \begin{matrix}{x}_{0} \\ {x}_{1} \\ {x}_{2} \\ {x}_{3} \\ {x}_{4} \\ {x}_{5} \\ {x}_{6} \\ {x}_{7}\end{matrix} ] = [ \begin{matrix}{r}_{0} \\ {r}_{1} \\ {r}_{2} \\ {r}_{3} \\ {r}_{4} \\ {r}_{5} \\ {r}_{6} + {a}_{6 , 0} {x}_{0} \\ {r}_{7} + {a}_{7 , 1} {x}_{1}\end{matrix} ] + [ \begin{matrix}{y}_{0} + {a}_{6 , 0} {x}_{6} \\ {y}_{1} + {a}_{7 , 1} {x}_{7} \\ {y}_{2} \\ {y}_{3} \\ {y}_{4} \\ {y}_{5} \\ {y}_{6} \\ {y}_{7}\end{matrix} ] + [ \begin{matrix}{s}_{0} \\ {s}_{1} \\ {s}_{2} \\ {s}_{3} \\ {s}_{4} \\ {s}_{5} \\ {s}_{6} \\ {s}_{7}\end{matrix} ] .$$

After completing all stages, all threads may simultaneously add the corresponding storage matrices (r₂ and s_{z}) in the respective storage devices to the memory y_{z}. No write conflicts may occur in the operation. It should be noted that, if the threads process the top four rows, both r₂ and s₂ may be processed by the i-th thread. Therefore, no write conflicts may occur in the operation.

According to some embodiments of the present disclosure, the parallel computation method for multiplying the symmetric matrix with the vector are provided, which can improve the accuracy and efficiency of multiplication computation between the symmetric matrix and the vector. By reasonably planning a sequence for processing the elements in the matrix, thread resources can be reasonably allocated, which can avoid write conflicts effectively and cause the plurality of threads to compute in parallel, thereby improving the efficiency of the computation, balancing thread loads, and reasonably distributing the thread resources.

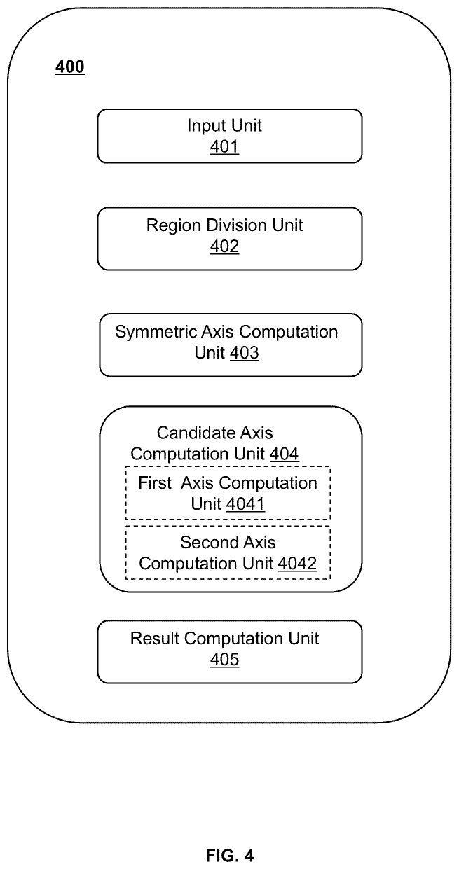

FIG. 4 is a schematic diagram illustrating an exemplary structure of a parallel computation system 400 for multiplying a symmetric matrix with a vector according to some embodiments of the present disclosure.

In some embodiments, the parallel computation system 400 may be implemented on a computing device having at least one processor and at least one storage device. The at least one processor may include a plurality of threads capable of parallel computation, and the at least one storage device may include a first storage device, a second storage device, and a third storage device. The parallel computation system 400 may include an input unit 401, a region division unit 402, a symmetric axis computation unit 403, a candidate axis computation unit 404, and a result computation unit 405.

The input unit 401 may be configured to acquire a symmetric matrix and a vector to be computed, and determine a count of the plurality of threads.

The region division unit 402 may be configured to divide the symmetric matrix into a symmetric axis region, an upper triangular region, and a lower triangular region based on a symmetric axis of the symmetric matrix. The region division unit 402 may be also configured to divide the upper triangular region or the lower triangular region into one or more subregions in rows based on the count of the plurality of threads.

The symmetric axis computation unit 403 may be configured to obtain symmetric axis data by determining a product of the symmetric axis region and the vector, and write the symmetric axis data into one of the first storage device, the second storage device, and the third storage device.

The candidate axis computation unit 404 may be configured to, for each of the one or more subregions, determine one or more candidate axes parallel to the symmetric axis, and for each of the one or more candidate axes, obtain two sets of data or four sets of data by performing two multiplication operations on the candidate axis through at least a portion of the plurality of threads, and write the two sets of data respectively into the at least one storage device, or write the four sets of data respectively into the first storage device, the second storage device, or the third storage device.

The result computation unit 405 may be configured to obtain a result of multiplying the symmetric matrix with the vector by constructing a target matrix based on accumulated data in the first storage device, the second storage device, and the third storage device after computing the symmetric axis region and the one or more subregions.

In some embodiments, the region division unit 402 may be further configured to divide the upper triangular region or the lower triangular region into at least one of a first subregion and a second subregion. A count of rows in the first subregion may be equal to the count of the plurality of threads, and a count of rows in the second subregion may be less than the count of the plurality of threads.

In some embodiments, in each first subregion, the candidate axis computation unit 404 may be configured to determine the one or more candidate axes including at least one first axis and at least one second axis. A count of elements in the first axis may be equal to the count of the plurality of threads, and a count of elements in the second axis may be less than the count of the plurality of threads. In each second subregion, the candidate axis computation unit 404 may be configured to determine the one or more candidate axes including at least one second axis.

In some embodiments, the candidate axis computation unit 404 may include a first axis computation unit 4041 and a second axis computation unit 4042. For each first axis, the candidate axis computation unit 404 (e.g., the first axis computation unit 4041) may be configured to obtain the two sets of data by performing two first multiplication operations on the first axis through the plurality of threads, write one of the two sets of data into one of the first storage device and the second storage device, and write the other one of the two sets of data into the other one of the first storage device and the second storage device.

In some embodiments, the first storage device may include a first storage matrix, and the second storage device may include a second storage matrix. The first axis computation unit 4041 may be further configured to perform a multiplication operation between an element a_{i,j} in the candidate axis and an element xⱼ in the vector to obtain a product a_{i,j}xⱼ, and perform a multiplication operation between the element a_{i,j} and an element xᵢ in the vector to obtain a product a_{i,j}xᵢ; accumulate the product a_{i,j}xⱼ into an i-th row rᵢ of the first storage matrix in the first storage device; and accumulate the product a_{i,j}xᵢ into a j-th row yⱼ of the second storage matrix in the second storage device.

For each second axis, the candidate axis computation unit 404 (e.g., the second axis computation unit 4042) may be configured to determine whether a complementary second axis of the second axis exists. The complementary second axis may be a second axis located in the same subregion as the second axis, and a sum of counts of elements in the complementary second axis and the second axis may be equal to the count of the plurality of threads. When a complementary second axis does not exist, the candidate axis computation unit 404 (e.g., the second axis computation unit 4042) may be configured to obtain the two sets of data by performing two second multiplication operations on the second axis through at least the portion of the plurality of threads, write one of the two sets of data into one of the first storage device and the second storage device, and write the other one of the two sets of data into the other one of the first storage device and the second storage device. When a complementary second axis exists, the candidate axis computation unit 404 (e.g., the second axis computation unit 4042) may be configured to obtain four sets of data by performing the two second multiplication operations on the second axis and a complementary second axis, respectively, and write the four sets of data into the first storage device, the second storage device, and the third storage device, respectively.

In some embodiments, the first storage device may include a first storage matrix, the second storage device may include a second storage matrix, the third storage device may include a third storage matrix. When a complementary second axis does not exist, the second axis computation unit 4042 may be configured to perform a multiplication operation between an element a_{i,j} in the second axis and an element xⱼ in the vector to obtain a product a_{i,j}xⱼ, and perform multiplication operation between the element a_{i,j} and an element xᵢ in the vector to obtain a product a_{i,j}xᵢ; accumulate the product a_{i,j}xⱼ into an i-th row rᵢ of the first storage matrix in the first storage device; and accumulate the product a_{i,j}xᵢ into a j-th row yⱼ of the second storage matrix in the second storage device. When a complementary second axis exists, the second axis computation unit 4042 may be configured to perform a multiplication operation between the element a_{i,j} on the second axis and the element xⱼ in the vector to obtain a product a_{i,j}xⱼ, perform a multiplication operation between the element a_{i,j} and the element xⱼ in the vector to obtain a product a_{i,j}xᵢ, perform a multiplication operation between an element a_{m,n} in the complementary second axis and an element xₙ in the vector to obtain a product a_{m,n} xₙ , and perform a multiplication operation between the element aₘ, and an element xₘ in the vector to obtain a product a_{m,n} xₙ; accumulate the product a_{i,j}xⱼ into the i-th row rᵢ of the first storage matrix in the first storage device; accumulate the product a_{i,j}xᵢ into the j-th row yⱼ of the second storage matrix in the second storage device; accumulate the product a_{m,n} xₙ into an m-th row yₘ of the second storage matrix in the second storage device; and accumulate the product a_{m,n} xₙ into an n-th row sₙ of the third storage matrix in the third storage device.

In some embodiments, the counts of elements in the second axis and the complementary second axis may be different, and the four sets of data may include two first sets of data and two second sets of data. The second axis computation unit 4042 may be further configured to obtain the two first sets of data by performing the two multiplication operations on one of the second axis and the complementary second axis with a greater count of elements, write one of the two first sets of data into one of the first storage device and the second storage device, write the other one of the two first sets of data is written into the other one of the first storage device and the second storage device; and obtain the two second sets of data by performing the two multiplication operations on the other one of the second axis and the complementary second axis with a smaller count of elements, write one of the two second sets of data into the third storage device, write the other one of the two second sets of data into the first storage device or the second storage device.

According to some embodiments of the present disclosure, the parallel computation system for multiplying the symmetric matrix with the vector are provided, which can improve the accuracy and efficiency of multiplication computation between the symmetric matrix and the vector. By reasonably planning a sequence for processing the elements in the matrix, thread resources can be reasonably allocated, which can avoid write conflicts effectively and cause the plurality of threads to compute in parallel, thereby improving the efficiency of the computation, balancing thread loads, and reasonably distributing the thread resources.

It should be noted that the above drawings are merely schematic diagrams illustrating preferred implementation scenarios, and are not intended to limit the scope of the present disclosure. For persons having ordinary skills in the art, the modules in the system in the implementation scenario can be distributed in the system according to the descriptions of the implementation scenario, or can be changed accordingly and located in one or more devices different from the present implementation scenario. In some embodiments, any two of the modules may be combined as a single module, and any one of the modules may be divided into two or more units. The numbering of the present disclosure is merely for purposes of illustration, and does not represent the superiority or inferiority of the implementation scenarios. For persons having ordinary skills in the art, various variations and modifications may be conducted under the guidance of the present disclosure. However, those variations and modifications do not depart from the scope of the present disclosure.

What is claimed is:

1. A parallel computation method for multiplying a symmetric matrix with a vector, implemented on a computing device having at least one processor and at least one storage device, the at least one processor including a plurality of threads capable of parallel computation, and the at least one storage device including a first storage device, a second storage device, and a third storage device, the method comprising:
acquiring a symmetric matrix and a vector to be computed;
determining a count of the plurality of threads;
dividing, based on a symmetric axis of the symmetric matrix, the symmetric matrix into a symmetric axis region, an upper triangular region, and a lower triangular region;
obtaining symmetric axis data by determining a product of the symmetric axis region and the vector, and writing the symmetric axis data into one of the first storage device, the second storage device, and the third storage device;
dividing, based on the count of the plurality of threads, the upper triangular region or the lower triangular region into one or more subregions in rows;
for each of the one or more subregions,
determining one or more candidate axes parallel to the symmetric axis;
for each of the one or more candidate axes, obtaining two sets of data or four sets of data by performing two multiplication operations on the candidate axis through at least a portion of the plurality of threads, and writing the two sets of data respectively into the first storage device or the second storage device, or writing the four sets of data respectively into the first storage device, the second storage device, or the third storage device; and
obtaining a result of multiplying the symmetric matrix with the vector by constructing a target matrix based on accumulated data in the first storage device, the second storage device, and the third storage device after computing the symmetric axis region and the one or more subregions.

2. The parallel computation method of claim 1, wherein the first storage device and the third storage device are registers, and the second storage device is a memory.

3. The parallel computation method of claim 2, wherein a first distance between the at least one processor and each of the first storage device and the third storage device is less than a second distance between the at least one processor and the second storage device.

4. The parallel computation method of claim 2, wherein a first storage capacity of the first storage device or the third storage device is smaller than a second storage capacity of the second storage device.

5. The parallel computation method of claim 1, wherein the dividing, based on the count of the plurality of threads, the upper triangular region or the lower triangular region into one or more subregions in rows includes:
dividing the upper triangular region or the lower triangular region into at least one of a first subregion and a second subregion, wherein a count of rows in the first subregion is equal to the count of the plurality of threads, and a count of rows in the second subregion is less than the count of the plurality of threads.

6. The parallel computation method of claim 5, wherein for each of the one or more subregions, the determining one or more candidate axes parallel to the symmetric axis includes:
in each first subregion, determining the one or more candidate axes including at least one first axis and at least one second axis, wherein a count of elements in the first axis is equal to the count of the plurality of threads, and a count of elements in the second axis is less than the count of the plurality of threads; and
in each second subregion, determining the one or more candidate axes including at least one second axis.

7. The parallel computation method of claim 6, wherein for each first axis, two sets of data are obtained by performing two first multiplication operations on the first axis through the plurality of threads, one of the two sets of data is written into one of the first storage device and the second storage device, and the other one of the two sets of data is written into the other one of the first storage device and the second storage device.

8. The parallel computation method of claim 7, wherein the first storage device includes a first storage matrix, the second storage device includes a second storage matrix, and the two first multiplication operations include:
performing a multiplication operation between an element a_{i,j} in the first axis and an element xⱼ in the vector to obtain a product a_{i,j}xⱼ, and performing a multiplication operation between the element a_{i,j} and an element xᵢ in the vector to obtain a product a_{i,j}xᵢ;
accumulating the product a_{i,j}xⱼ into an i-th row rᵢ of the first storage matrix in the first storage device; and
accumulating the product a_{i,j}xᵢ into a j-th row yⱼ of the second storage matrix in the second storage device.

9. The parallel computation method of claim 6, wherein for each second axis, the parallel computation method further comprises:
determining whether a complementary second axis of the second axis exists, the complementary second axis being a second axis located in the same subregion as the second axis, and a sum of counts of elements in the complementary second axis and the second axis being equal to the count of the plurality of threads, wherein:
when a complementary second axis does not exist, two sets of data are obtained by performing the two second multiplication operations on the second axis through a portion of the plurality of threads, one of the two sets of data is written into one of the first storage device and the second storage device, and the other one of the two sets of data is written into the other one of the first storage device and the second storage device; or when a complementary second axis exists, four sets of data are by obtained by performing the two second multiplication operations on the second axis and the complementary second axis, respectively, and the four sets of data are written into the first storage device, the second storage device, and the third storage device, respectively.

10. The parallel computation method of claim 9, wherein the first storage device includes a first storage matrix, the second storage device includes a second storage matrix, the third storage device includes a third storage matrix, when a complementary second axis does not exist, the performing the two second multiplication operations on the second axis includes: performing a multiplication operation between an element a_{i,j} in the second axis and an element xⱼ in the vector to obtain a product a_{i,j}xⱼ, and performing a multiplication operation between the element a_{i,j} and an element xᵢ in the vector to obtain a product a_{i,j}xᵢ; accumulating the product a_{i,j}xⱼ into an i-th row rᵢ of the first storage matrix in the first storage device; and accumulating the product a_{i,j}xᵢ into a j-th row yⱼ of the second storage matrix in the second storage device; or
when a complementary second axis exists, the performing the two second multiplication operations on the second axis and the complementary second axis, respectively, comprises:
performing a multiplication operation between the element a_{i,j} on the second axis and the element xⱼ in the vector to obtain a product a_{i,j}xⱼ,
performing a multiplication operation between the element a_{i,j} and the element xᵢ in the vector to obtain a product a_{i,j}xᵢ,
performing a multiplication operation between an element a_{m,n} in the complementary second axis and an element xₙ in the vector to obtain a product a_{m,n}xₙ,
performing a multiplication operation between the element a_{m,n} and an element xₘ in the vector to obtain a product a_{m,n}xₘ;
accumulating the product a_{i,j}xⱼ into an i-th row rᵢ of the first storage matrix in the first storage device;
accumulating the product a_{i,j}xᵢ into a j-th row yⱼ of the second storage matrix in the second storage device;
accumulating the product a_{m,n}xₙ into an m-th row yₘ of the second storage matrix in the second storage device; and
accumulating the product a_{m,n}xₘ into an n-th row sₙ of the third storage matrix in the third storage device.

11. The parallel computation method of claim 9, wherein the counts of elements in the second axis and the complementary second axis are different,
the four sets of data include two first sets of data and two second sets of data,
the two first sets of data are obtained by performing the two multiplication operations on one of the second axis and the complementary second axis with a greater count of elements, one of the two first sets of data is written into one of the first storage device and the second storage device, the other one of the two first sets of data is written into the other one of the first storage device and the second storage device; and
the two second sets of data are obtained by performing the two multiplication operations on the other one of the second axis and the complementary second axis with a smaller count of elements, one of the two second sets of data is written into the third storage device, the other one of the two second sets of data is written into the first storage device or the second storage device.

12. The parallel computation method of claim 5, wherein an order of the symmetric matrix is denoted as M, and the count of the plurality of threads is denoted as L, wherein
when M=2nL+1, the upper triangular region or the lower triangular region is divided into 2n first subregions in rows based on the count of the plurality of threads, wherein M, L, and n are positive integers.

13. A parallel computation system for multiplying a symmetric matrix with a vector, comprising:
at least one storage device includes a set of instructions, the at least one storage device including a first storage device, a second storage device, and a third storage device;
at least one processor configured to communicate with the at least one storage device, the at least one processor including a plurality of threads capable of parallel computation, wherein when executing the set of instructions, the at least one processor is configured to direct the system to perform at least one operation including:
acquiring a symmetric matrix and a vector to be computed;
determining a count of the plurality of threads;
dividing, based on a symmetric axis of the symmetric matrix, the symmetric matrix into a symmetric axis region, an upper triangular region, and a lower triangular region;
obtaining symmetric axis data by determining a product of the symmetric axis region and the vector, and writing the symmetric axis data into one of the first storage device, the second storage device, and the third storage device;
dividing, based on the count of the plurality of threads, the upper triangular region or the lower triangular region into one or more subregions in rows;
for each of the one or more subregions,
determining one or more candidate axes parallel to the symmetric axis;
for each of the one or more candidate axes, obtaining two sets of data or four sets of data by performing two multiplication operations on the candidate axis through at least a portion of the plurality of threads, and writing the two sets of data respectively into the first storage device or the second storage device, or writing the four sets of data respectively into the first storage device, the second storage device, or the third storage device; and
obtaining a result of multiplying the symmetric matrix with the vector by constructing a target matrix based on accumulated data in the first storage device, the second storage device, and the third storage device after computing the symmetric axis region and the one or more subregions.

14. The parallel computation system of claim 13, wherein the dividing, based on the count of the plurality of threads, the upper triangular region or the lower triangular region into one or more subregions in rows includes:
dividing the upper triangular region or the lower triangular region into at least one of a first subregion and a second subregion, wherein a count of rows in the first subregion is equal to the count of the plurality of threads, and a count of rows in the second subregion is less than the count of the plurality of threads.

15. The parallel computation system of claim 14, wherein for each of the one or more subregions, the determining one or more candidate axes parallel to the symmetric axis includes:
in each first subregion, determining the one or more candidate axes including at least one first axis and at least one second axis, wherein a count of elements in the first axis is equal to the count of the plurality of threads, and a count of elements in the second axis is less than the count of the plurality of threads; and
in each second subregion, determining the one or more candidate axes including at least one second axis.

16. The parallel computation system of claim 15, wherein for each first axis, two sets of data are obtained by performing two first multiplication operations on the first axis through the plurality of threads, one of the two sets of data is written into one of the first storage device and the second storage device, and the other one of the two sets of data is written into the other one of the first storage device and the second storage device.

17. The parallel computation system of claim 16, wherein the first storage device includes a first storage matrix, the second storage device includes a second storage matrix, and the two first multiplication operations include:
performing a multiplication operation between an element a_{i,j}in the first axis and an element xⱼ in the vector to obtain a product a_{i,j}xⱼ, and performing a multiplication operation between the element a_{i,j} and an element xⱼ in the vector to obtain a product a_{i,j}xᵢ;
accumulating the product a_{i,j}xⱼ into an i-th row rᵢ of the first storage matrix in the first storage device; and
accumulating the product a_{i,j}xᵢ into a j-th row yⱼ of the second storage matrix in the second storage device.

18. The parallel computation method of claim 15, wherein for each second axis, the parallel computation method further comprises:
determining whether a complementary second axis of the second axis exists, the complementary second axis being a second axis located in the same subregion as the second axis, and a sum of counts of elements in the complementary second axis and the second axis being equal to the count of the plurality of threads, wherein:
when a complementary second axis does not exist, two sets of data are obtained by performing the two second multiplication operations on the second axis through a portion of the plurality of threads, one of the two sets of data is written into one of the first storage device and the second storage device, and the other one of the two sets of data is written into the other one of the first storage device and the second storage device; or
when a complementary second axis exists, four sets of data are by obtained by performing the two second multiplication operations on the second axis and the complementary second axis, respectively, and the four sets of data are written into the first storage device, the second storage device, and the third storage device, respectively.

19. The parallel computation method of claim 18, wherein the first storage device includes a first storage matrix, the second storage device includes a second storage matrix, the third storage device includes a third storage matrix,
when a complementary second axis does not exist, the performing the two second multiplication operations on the second axis includes: performing a multiplication operation between an element a_{i,j} in the second axis and an element xⱼ in the vector to obtain a product di,jXj, and performing a multiplication operation between the element a_{i,j} and an element xⱼ in the vector to obtain a product a_{i,j}xᵢ; accumulating the product a_{i,j}xⱼ into an i-th row rᵢ of the first storage matrix in the first storage device; and accumulating the product a_{i,j}xᵢ into a j-th row yⱼ of the second storage matrix in the second storage device; or
when a complementary second axis exists, the performing the two second multiplication operations on the second axis and the complementary second axis, respectively, comprises:
performing a multiplication operation between the element a_{i,j} on the second axis and the element xⱼ in the vector to obtain a product a_{i,j}xⱼ,
performing a multiplication operation between the element a_{i,j} and the element xᵢ in the vector to obtain a product a_{i,j}xᵢ,
performing a multiplication operation between an element aₘ, in the complementary second axis and an element xₙ in the vector to obtain a product a_{m,n}xₙ,
performing a multiplication operation between the element aₘ, and an element xm in the vector to obtain a product a_{m,n}xₘ;
accumulating the product a_{i,j}xⱼ into an i-th row rᵢ of the first storage matrix in the first storage device;
accumulating the product a_{i,j}xᵢ into a j-th row yⱼ of the second storage matrix in the second storage device;
accumulating the product a_{m,n}xₙ into an m-th row yₘ of the second storage matrix in the second storage device; and
accumulating the product aa_{m,n}xₘ into an n-th row sₙ of the third storage matrix in the third storage device.

20. A non-transitory computer readable medium comprising at least one set of instructions, wherein when executed by a computing device having at least one processor and at least one storage device, the at least one processor including a plurality of threads capable of parallel computation, and the at least one storage device including a first storage device, a second storage device, and a third storage device, the at least one set of instruction direct the computing device to perform a method including:
acquiring a symmetric matrix and a vector to be computed;
determining a count of the plurality of threads;
dividing, based on a symmetric axis of the symmetric matrix, the symmetric matrix into a symmetric axis region, an upper triangular region, and a lower triangular region;
obtaining symmetric axis data by determining a product of the symmetric axis region and the vector, and writing the symmetric axis data into one of the first storage device, the second storage device, and the third storage device;
dividing, based on the count of the plurality of threads, the upper triangular region or the lower triangular region into one or more subregions in rows;
for each of the one or more subregions,
determining one or more candidate axes parallel to the symmetric axis;
for each of the one or more candidate axes, obtaining two sets of data or four sets of data by performing two multiplication operations on the candidate axis through at least a portion of the plurality of threads, and writing the two sets of data respectively into the first storage device or the second storage device, or writing the four sets of data respectively into the first storage device, the second storage device, or the third storage device; and
obtaining a result of multiplying the symmetric matrix with the vector by constructing a target matrix based on accumulated data in the first storage device, the second storage device, and the third storage device after computing the symmetric axis region and the one or more subregions.
